(19) United States
(12) Patent Application Publication
(10) Pub. No.: US 2006/0150165 A1
(43) Pub. Date: Jul. 6, 2006

(54) Virtual microengine systems and methods

(75) Inventors: Donald F. Hooper, Shrewsbury, MA (US); Prashant R. Chandra, Sunnyvale, CA (US); James D. Guilford, Northborough, MA (US); Mark B. Rosenbluth, Uxbridge, MA (US)

Correspondence Address: Jung-hua Kuo Attorney at Law;PortfolioIP, P.O. Box 52050, Minneapolis, MN, 55402, US

(73) Assignee: Intel Corporation, Santa Clara, CA (US)

(21) Appl. No.: 11/027,785

(22) Filed: Dec. 30, 2004

(51) Int. Cl. G06F 9/45

(52) U.S. Cl. 717/140

(57) ABSTRACT

Systems and methods are disclosed for supporting virtual microengines in a multithreaded processor, such as a microengine running on a network processor. In one embodiment code is written for execution by a plurality of virtual microengines. The code is than compiled and linked for execution on a physical microengine, at which time the physical microengine's threads are assigned to thread groups corresponding to the virtual microengines. Internal next neighbor rings are allocated within the physical microengine to facilitate communication between the thread groups. The code can then be loaded onto the physical microengine and executed, with each thread group executing the code written for its corresponding virtual microengine.

### BACKGROUND

Advances in networking technology have led to the use of computer networks for a wide variety of applications, such as sending and receiving electronic mail, browsing Internet web pages, exchanging business data, and the like. As the use of computer networks proliferates, the technology upon which these networks are based has become increasingly complex.

Data is typically sent over a network in small packages called packets, which may be routed over a variety of intermediate network nodes before reaching their ultimate destination. These intermediate nodes (e.g., routers, switches, and the like) are often complex computer systems in their own right, and may include a variety of specialized hardware and software components.

For example, some network nodes may include one or more network processors for processing packets for use by higher-level applications. Network processors are typically comprised of a variety of components, including one or more processing units, memory units, buses, controllers, and the like. Network processors may be programmable, thereby enabling the same basic hardware to be used for a variety of applications. Many network processors include multiple processors, or microengines, each with its own memory, and each capable of running its own programs.

With the proliferation of networking applications and programmable network processors, the programming process itself is becoming increasingly important.

### BRIEF DESCRIPTION OF THE DRAWINGS

Reference will be made to the following drawings, in which:

FIG. 1 is a diagram of a network processor.

FIG. 2 illustrates the use of virtual microengines to facilitate network processor programming.

FIG. 3 is an illustration of a process for generating and executing a program on a network processor.

FIGS. 4A and 4B illustrate the mapping of virtual microengines onto physical microengines in a network processor.

FIG. 5 is a more detailed illustration of the mapping of virtual microengines onto a physical microengine.

FIG. 6 is an illustration of a process for configuring a program written for a virtual microengine to run on a physical microengine.

FIGS. 7A and 7B are illustrations of code images produced by the process described in connection with FIG. 6.

FIG. 8 shows an illustrative system upon which programs such as those shown in FIGS. 7A and 7B can be run.

### DESCRIPTION OF SPECIFIC EMBODIMENTS

Systems and methods are disclosed for facilitating the process of writing programs for network processors and the multi-threaded processing engines that they contain. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. For example, although several examples are provided in the context of Intel® Internet Exchange network processors, it will be appreciated that the same principles can be readily applied in other contexts as well. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

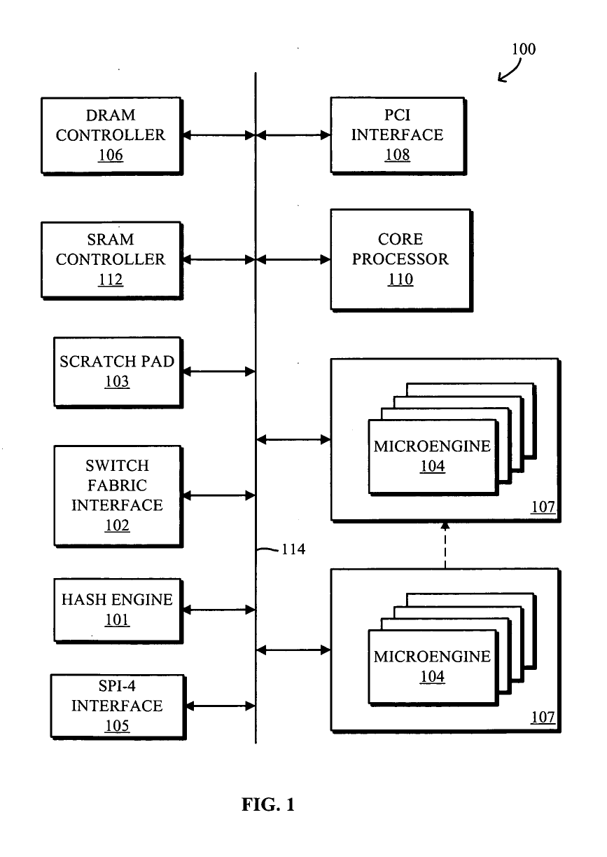

Network processors are used to perform packet processing and other networking operations. An example of a network processor 100 is shown in FIG. 1. Network processor 100 has a collection of processing engines 104, arranged in clusters 107. Processing engines 104 may, for example, comprise multi-threaded, Reduced Instruction Set Computing (RISC) processors tailored for packet processing. As shown in FIG. 1, network processor 100 may also include a core processor 110 (e.g., an Intel XScale® processor) that may be programmed to perform control plane tasks involved in network operations, such as signaling stacks and communicating with other processors. The core processor 110 may also handle some data plane tasks, and may provide additional packet processing threads.

Network processor 100 may also feature a variety of interfaces that carry packets between network processor 100 and other network components. For example, network processor 100 may include a switch fabric interface 102 (e.g., a Common Switch Interface (CSIX)) for transmitting packets to other processor(s) or circuitry connected to the fabric; a media interface 105 (e.g., a System Packet Interface Level 4 (SPI-4) interface) that enables network processor 100 to communicate with physical layer and/or link layer devices; an interface 108 for communicating with a host (e.g., a Peripheral Component Interconnect (PCI) bus interface); and/or the like.

Network processor 100 may also include other components shared by the engines 104 and/or core processor 110, such as one or more static random access memory (SRAM) controllers 112, dynamic random access memory (DRAM) controllers 106, a hash engine 101, and a relatively low-latency, on-chip scratch pad memory 103 for storing frequently used data. One or more internal buses 114 are used to facilitate communication between the various components of the system.

As previously indicated, processing engines 104 may, for example, comprise multi-threaded RISC processors having self-contained instruction and data memory to enable rapid access to locally stored code and data. Processing engines 104 may also include one or more hardware-based coprocessors for performing specialized functions such as serialization, cyclic redundancy checking (CRC), cryptography, High-Level Data Link Control (HDLC) bit stuffing, and/or the like. The multi-threading capability of engines 104 may be supported by hardware that reserves different registers for different threads and can quickly swap thread contexts. Engines 104 may communicate with neighboring processing engines 104 via, e.g., shared memory and/or next-neighbor registers.

It will be appreciated that FIG. 1 is provided for purposes of illustration, and not limitation, and that the systems and methods described herein can be practiced with devices and architectures that lack some of the components and features shown in FIG. 1 and/or that have other components or features that are not shown. Moreover, although processing engines such as processing engines 104 will be referred to herein as “microengines”—a term that is often associated with the processing engines found on Intel Internet Exchange network processors—it should be understood that the term “microengine” is used herein to refer generically to any network processor's processing engines, and is not limited to a specific network processor architecture.

A network processor will often be called upon to process packets corresponding to many different data streams (e.g., transmission control protocol/Internet protocol (TCP/IP) steams). To do this, the network processor may process multiple streams in parallel. For example, Intel Internet Exchange processors use groups of microengines to process incoming packets, each microengine having specific hardware-supported threads, and each thread having its own general purpose and input/output transfer registers, enabling rapid swapping between contexts.

In effect, multiple threads can be simultaneously active on a microengine even though only one thread is actually operating at any given time. Each microengine may maintain a plurality of program counters in hardware, and states associated with the program counters. When a first thread initiates a transaction, such as an access to memory, other threads with unique program counters are able to execute on the same microengine while the first thread is waiting for data to return from memory.

Similarly, different microengines may be programmed to perform different tasks. For example, different microengines within a network processor may perform different operations on incoming data, with each of the threads in a particular microengine performing the same operations in parallel, but on different data (e.g., different packets). The microengines may effectively form a pipeline in which a first microengine or group of microengines perform a first operation on incoming data, then pass control to a next microengine or group of microengines to perform a second task on the data, and so forth. Communication between the microengines is facilitated by next-neighbor ring buffers.

Many conventional microengines support either four or eight threads, and code for these microengines is typically written for the specific number of threads that the particular microengine supports. When porting code to other microengines (e.g., from a microengine that supports eight threads to a microengine that supports only four threads), or when running the code at varying performance levels, the code will need to be adjusted in order to achieve the desired performance or to obtain optimal code efficiency. Significant effort is required to rewrite and maintain code for different processors and for different performance levels. What is needed is a way to facilitate code reusability and portability, so that software developers can leverage the work done by other programmers rather than having to write each new program from scratch, recoding many of the same basic modules for each different platform.

One way to address this problem is to include alternative coding constructs in each program for handling each possible platform that the program may encounter. For example, if a program is written in the C programming language or a variant thereof, a large number of #ifdef statements can be included in the program, the #ifdef statements defining how the program is to behave if it is loaded on specific hardware platforms and/or systems with different performance characteristics. The use of #ifdef statements is thus able to achieve a degree of portability, although it is also a relatively cumbersome solution, as it results in source code that is difficult to read and maintain, and requires programmers to be familiar with each of the potential hardware architectures (past, present, and future) on which their programs may run.

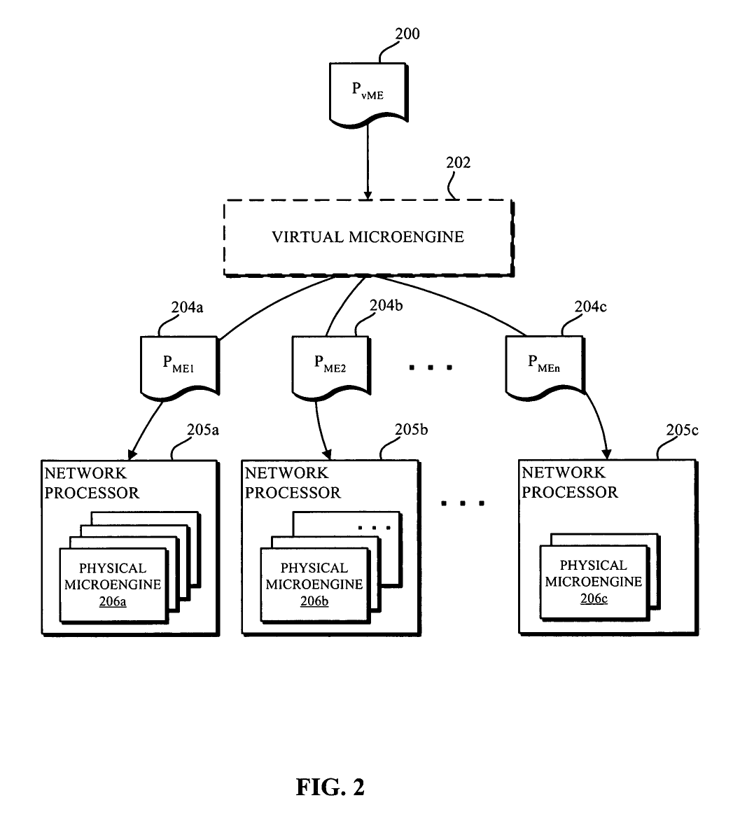

Thus, in another embodiment, a software abstraction referred to as a virtual microengine is used to map software to the physical microengines on which it will ultimately run. As shown in FIG. 2, a virtual microengine 202 is used as an abstraction onto which programmers can write their applications 200. Hardware and/or software on the network processor then takes programs 200 written to the abstract, virtual microengine 202, and translates these programs 200 into programs 204 tailored to the particular network processors 205a, 205b, 205c and corresponding physical microengines 206a, 206b, or 206c upon which the specific program instances are to run. The virtual microengine abstraction thus shields the programmer from the underlying hardware details of network processors 205 and microengines 206, which may have a range of performance and cost levels, and may include generations of hardware spanning many years. For example, the physical microengines 206a-206c on each of network processors 205a-205c may support a different number of threads and/or have a different performance level; however, the programmer need not account for these differences when writing program 200, but instead may simply program to the same, abstract virtual microengine 202. Such a programming approach greatly facilitates code development and portability, since code written to a virtual microengine can be used on multiple physical microengines, since it is not written for specific threads, microengines, or processors.

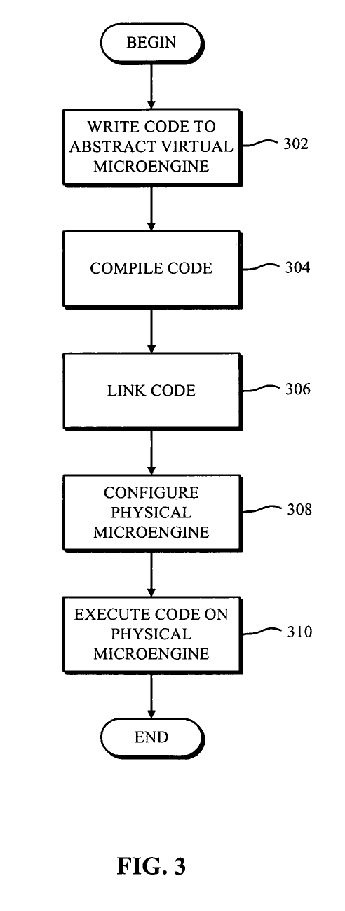

FIG. 3 is an illustration of a process for generating and executing a program on a network processor using virtual microengines. As shown in FIG. 3, the programmer or software developer writes code for an abstract, virtual microengine that is not tied to a specific physical microengine architecture (block 302). The source code is then compiled, (typically on the software developer's personal computer or workstation, although any suitable location could be used) (block 304). The compiled code is then loaded onto a network processor (e.g., into memory accessible to the network processor's core processor), where a linker is executed to tailor the code for execution on the network processor's specific physical microengines (block 306). The microengines themselves are also configured to support the virtual microengine architecture embodied in the code image (block 308). The resulting code image is then loaded onto the network processor's microengines, where it is used to process network traffic (block 310).

It will be appreciated that FIG. 3 has been provided for purposes of illustration, and that numerous modifications can be made to the process shown therein. For example, in some embodiments the compiler itself might be run on the network processor, where it might perform some or all of the code customization and other functions otherwise performed by the linker and/or loader. In other embodiments, the linker operations may be performed externally to the network processor. It should be appreciated that many, similar variations are also possible.

In one embodiment, the code written for each virtual microengine is designed as straight-line code that iteratively operates on successive data sets, as with the conventional, physical microengines describe above. As with physical microengines, in one embodiment virtual microengines communicate via message rings. A series of tasks can therefore be passed from one virtual microengine to the next. In one embodiment, the number of threads assigned to a virtual microengine is established at link time and set in hardware at load time, and is dependent on the virtual microengine's needs and on the characteristics and performance capabilities of the physical microengine.

As described in more detail below, the network processor's physical microengines are configured by, e.g., the loader to support the virtual microengines. For example, in one embodiment internal message rings are allocated for communication between virtual microengine thread groups on the same physical microengine, global local memory addresses are made global to the virtual microengine's thread group, content-addressable memory (CAM) lookup and evict entries are made local to the thread group, and next thread signaling is redirected inside or outside the physical microengine as appropriate.

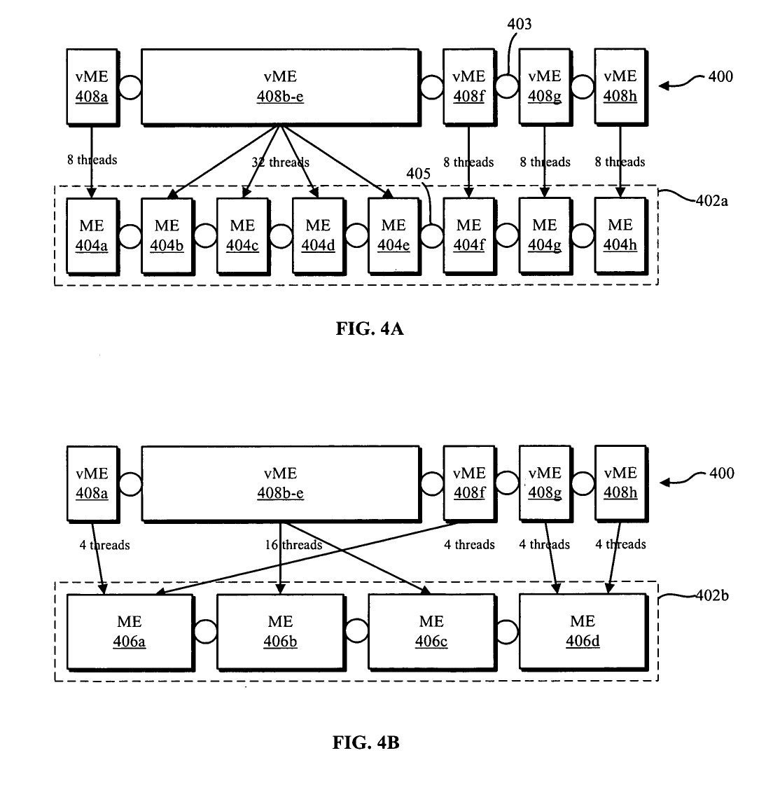

FIGS. 4A and 4B illustrate the mapping of virtual microengines onto physical microengines in a network processor. In particular, FIGS. 4A and 4B show the mapping of the same virtual microengine design 400 onto different processors 402a, 402b. The processor 402a shown in FIG. 4A is a higher performance processor, with eight physical microengines 404a-404h each capable of supporting eight threads, while the processor 402b shown in FIG. 4B is a lower performance processor, having only four microengines 406a-406d each capable of supporting eight threads. As shown in FIGS. 4A and 4B, microengines 404, 406 communicate with each other using next neighbor ring buffers 405.

As shown in FIG. 4A, the program that is to be loaded onto the network processor is designed to make use of eight virtual microengines 408a-408h, each of which communicates with its adjacent virtual microengines using virtual next neighbor ring buffers 403. For example, the program may comprise a sequence of eight tasks that are to be performed on incoming packets of data. Because the network processor 402a contains eight physical microengines 404a-404h, each virtual microengine 408 can be assigned to its own corresponding physical microengine 404, and each can make use of all of the physical microengine's threads and next neighbor buffers 405. This results in higher performance, since more threads are assigned per virtual microengine.

In FIG. 4B, the same virtual microengine architecture 400 is mapped onto a network processor 402b with only four microengines 406a-406d. Because the virtual microengine architecture 400 is designed to make use of eight virtual microengines 408a-408h, multiple virtual microengines 408 are assigned to each of the network processor's physical microengines 406, as illustrated in FIG. 4B. As a result, each virtual microengine 408 is only assigned four threads (i.e., half of each physical microengine's eight threads), and internal next neighbor buffers will need to be allocated to facilitate intra-microengine communication between adjacent virtual microengines.

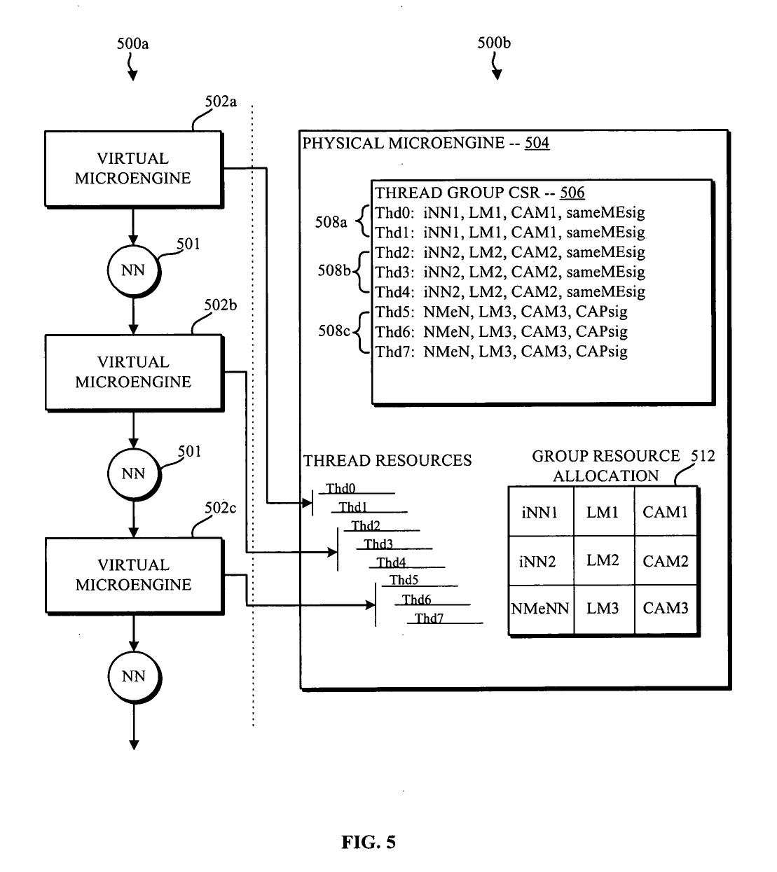

FIG. 5 is a more detailed illustration of the process of mapping virtual microengines 502 onto a physical microengine 504. The architecture 500a on the left side of FIG. 5 is an abstraction used by the software developer when writing a program for a network processor. The abstract architecture 500a includes three virtual microengines 502a-502c that communicate via virtual next neighbor rings 501. The architecture 500b on the right side of FIG. 5 shows how the abstraction 500a is actually implemented on a physical microengine 504.

In the embodiment shown in FIG. 5, the three virtual microengines 502a-502c are mapped onto a single physical microengine 504. The physical microengine 504 has eight threads (Thd0-Thd7), which are assigned in groups 508 to virtual microengines 502. In the example shown in FIG. 5, virtual microengine 502a is mapped to thread group 508a, comprised of threads Thd0 and Thd1; virtual microengine 502b corresponds to thread group 508b, comprised of threads Thd2-Thd4; and virtual microengine 502c corresponds to thread group 508c, comprised of threads Thd5-Thd7.

As shown in FIG. 5, when virtual microengine code is loaded onto a physical microengine 504, a thread group control status register (CSR) 506 in the physical microengine 504 is used to assign and configure thread groups 508 for each of the virtual microengines 502a-502c. For example, each thread group is assigned next neighbor in/out ring pointers. In the example shown in FIG. 5, the first thread group 508a has two threads (Thd0 and Thd1), each of which is assigned a pointer to an internal next neighbor ring, iNN1, which points to the next thread group 508b. The first thread group 508a uses the physical microengine's existing next neighbor ring to receive messages from another, external microengine and/or a thread group running on that microengine.

Similarly, the next thread group 508b, consisting of three threads (Thd2, Thd3, and Thd4), is assigned a pointer to a second internal next neighbor ring, iNN2, that points to the next thread group 508c. Thread group 508b receives messages from virtual microengine 502a (i.e., thread group 508a) via internal next neighbor ring, iNN1.

Finally, the last thread group 508c uses microengine 504's outward facing inter-microengine next neighbor ring, NMeN, to pass messages to the next, external physical microengine and/or a thread group running on that microengine.

Thus, virtual next neighbor rings 501 between virtual microengines 502a-502c are implemented on microengine 504 using a combination of the microengine's existing inter-microengine next-neighbor rings, and intra-microengine next neighbor rings that are allocated within the microengine. These intra-microengine rings can be implemented in any suitable manner, including, e.g., as partitions of the microengine's local memory, as partitions of the microengine's inter-microengine next neighbor ring buffer, and/or the like.

As shown in FIG. 5, the Thread Group CSR 506 also contains addressing information identifying the local memory assigned to each thread group (LM1, LM2, LM3). For example, when threads in a thread group read or write global local memory addresses, those reads and writes will be to the memory locations specified by the thread group's designated memory partition. As shown in FIG. 5, Thread Group CSR 506 also contains information regarding each thread group's partition of the microengine's content-addressable memory (CAM1, CAM2, CAM3), and information regarding the type of signaling that is used to communicate with other virtual microengines for purposes of, e.g., round robin thread processing. For example, in the case of thread groups 508a and 508b, signaling can be accomplished between threads on the same physical microengine (sameMEsig), while for thread group 508c, signaling a next virtual microengine involves signaling an external microengine (e.g., via the network processor's Control and Status Register Access Proxy (CAP) registers). As shown in FIG. 5, the microengine's Group Resource Allocation table 512 is updated to reflect the mappings described above.

Thus, each thread in the physical microengine is mapped to a thread group corresponding to a virtual microengine, with each thread group having a separate next neighbor ring, local memory address pointer, and CAM partition. Communication between virtual microengines within a microengine is accomplished via internal next neighbor rings. CAM lookups (e.g., entry groups and evictions) are specific to each virtual microengine; global local memory addresses are for the threads of a virtual microengine; and signals are redirected within the microengine or to another microengine, based on the location of the relevant virtual microengine thread.

It should be appreciated that FIGS. 4A, 4B, and 5 are provided for purposes of illustration, and not limitation, and that a number of modifications could be made without departing from the principles that are illustrated therein. For example, while physical microengines with four and eight threads are shown in FIGS. 4A and 4B, it should be appreciated that physical microengines capable of supporting any suitable number of threads could be used instead (e.g., 16, 32, etc.). Moreover, although virtual microengine 408b-e has been described as comprising four individual virtual microengines, it could alternatively be conceptualized as a single virtual microengine, illustrating that a single virtual microengine may, in some situations, span multiple physical microengines (e.g., microengines 404b-404e in FIG. 4A), while in other situations, multiple virtual microengines may be mapped to a single physical microengine, as shown in FIGS. 4B and 5.

The process of generating software for virtual microengines will now be described in more detail. In one embodiment, software is written as a root file hierarchy or collection of source files, targeted to a virtual microengine. In one embodiment, each virtual microengine's code is compiled to a list file. At link time, list files are assigned to individual hardware-supported groups of microengine threads, and a loadable image is produced, possibly including additional directives for initializing the thread groups. The linker sets the starting program counter (PC) for each virtual thread group, and adjusts the label locations accordingly. In some embodiments, the loader also initializes the physical microengines' control status registers to configure virtual microengine thread groups, internal next neighbor pointers, CAM settings, local memory addresses, and signal redirection, as illustrated in FIG. 5. In one embodiment, the loader also forces the starting PC for each thread to the value of the starting PC of the code for its associated thread group (virtual microengine). In some software implementations, the loader is incorporated in the device driver for the microengines. Using the methodology described above, the same software becomes portable across multiple chip types and between chips having varying levels of performance, simply by adjusting the number of threads assigned to each thread group.

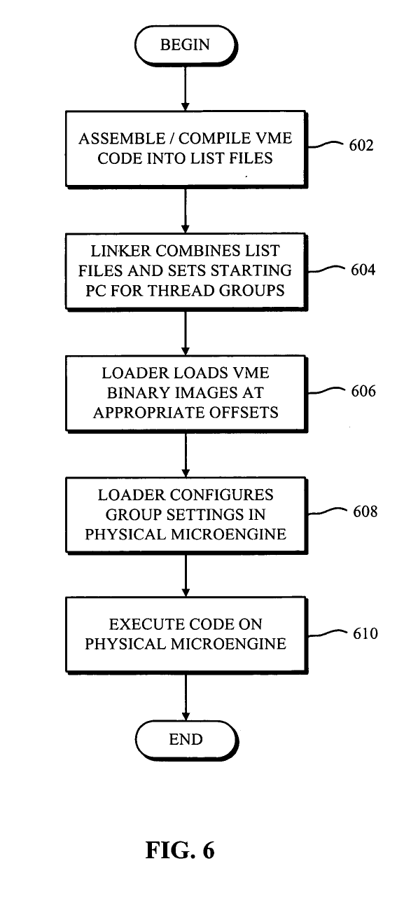

FIG. 6 shows an example of the build, load, and configure process in more detail. As shown in FIG. 6, an assembler or compiler creates an output list file for each virtual microengine (block 602). Linker directives specify the number of threads to run per virtual microengine, and the linker sets the starting PC address for each virtual microengine thread group, modifies the label and PC addresses to the thread group offset, and passes configuration settings to the loader (block 604). The loader loads the instructions for each virtual microengine into the physical microengine's instruction storage at the PC offset of the corresponding thread group (block 606). In the embodiment shown in FIG. 6, the loader also configures the hardware microengine by setting the appropriate starting PC value for each thread's dedicated program counter and configuring the microengine's control status register (block 608). For example, if the physical microengine provides the ability to specify the PC for each hardware thread, the loader can set this value to point to the location in the code image where the code for that thread's group begins. Once the code is loaded onto an appropriately configured physical microengine, the code can be executed (block 610).

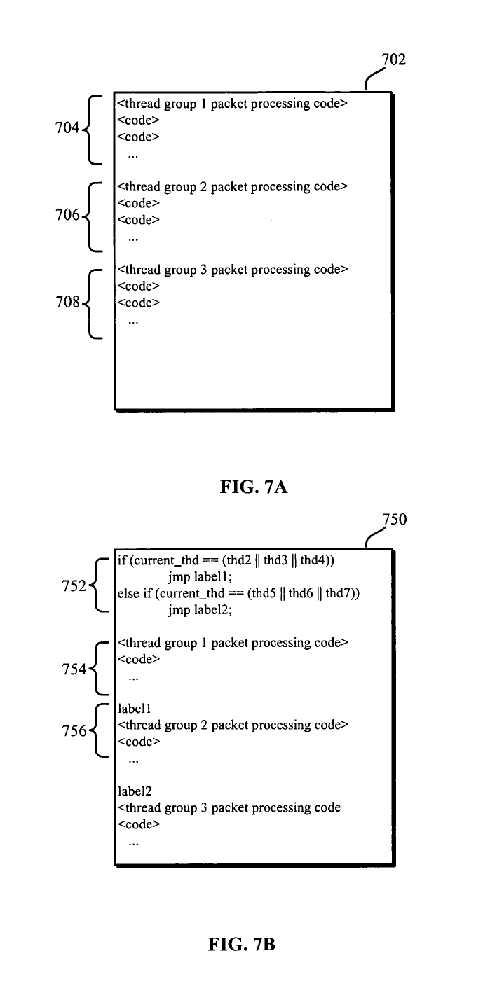

It should be appreciated that FIG. 6 is provided for purposes of illustration, and not limitation, and that a number of modifications could be made without departing from the principles that are illustrated therein. For example, in some embodiments, some of the blocks shown in FIG. 6 could be combined or eliminated. In some embodiments, for example, blocks 602-604 could be combined, with the assembler or compiler creating a single list file rather than a separate list file for each virtual thread. In such an embodiment, the assembler or compiler may also add branching information at the beginning of the code image to test the thread context, and to branch to the appropriate location in the image for the code that implements the actions of the corresponding virtual microengine. Such an embodiment is further illustrated in FIG. 7B.

FIGS. 7A and 7B are illustrations of possible embodiments of a code image corresponding to the virtual microengine configuration shown in FIG. 5. For example, code images 702, 750 could be loaded into a physical microengine's instruction storage as described in connection with FIG. 6. It will be appreciated that to facilitate explanation, code images 702, 750 are shown in pseudo-source code form, rather than binary.

As shown in FIG. 7A, code image 702 includes separate code segments 704, 706, and 708 for implementing the tasks to be performed on each of the virtual microengines 502a, 502b, and 502c. In one embodiment, each thread of a particular virtual microengine's thread group executes the same code in parallel. As shown in FIG. 7A, the code segments 704, 706, 708 for each thread group begin at different locations in the code image 702, which the physical microengine keeps track of using each thread's program counter (PC). Thus, when a particular thread executes, it begins to execute at the location specified in its PC register.

FIG. 7B shows an alternative embodiment to that shown in FIG. 7A. When a microengine begins execution of code image 750, it starts at the beginning of the code image (i.e., PC=0), where branching instructions 752 test which thread is executing and route the thread to the appropriate section of the code image 750 based on the thread group to which the thread belongs. For example, if it is determined that thread 0 is executing, then no branch is taken, and execution begins with the code for the first thread group 754. If, on the other hand, it is determined that thread 2 is executing, then execution branches to label1, since that is where the code 756 “running on” virtual microengine 502b (i.e., thread group 508b) in FIG. 5 is located.

Thus, embodiments of the systems and methods described herein can be used to enable portability of software across existing and future network processor chips, at a range of performance levels, with little or no modification to the source code. By providing an efficient mechanism for programming network processors, embodiments such as those described above can be used to further enhance the capabilities and desirability of programmable network processors over purely application-specific integrated circuit (ASIC) approaches;

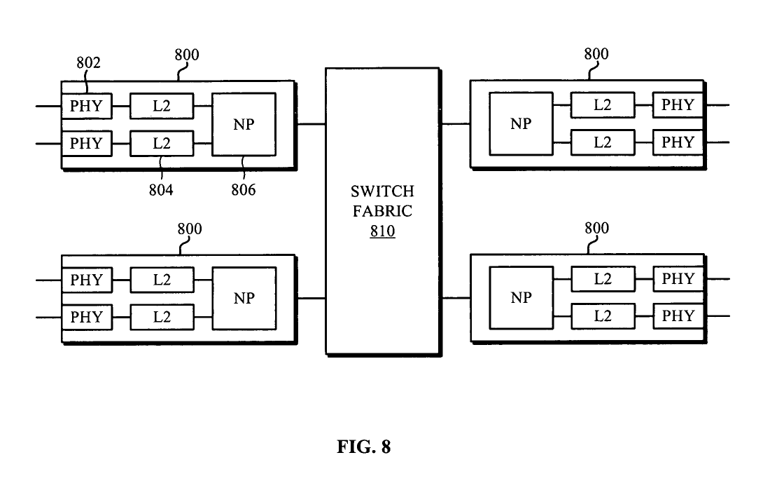

It should be appreciated that the techniques described above can be used by a variety of network systems. For example, the techniques described above can be implemented in a programmable network processor, such as that shown in FIG. 1, which may, in turn, form part of a larger system (e.g., a network device). FIG. 8 shows an example of such a system. As shown in FIG. 8, the system includes a collection of line cards or “blades” 800 interconnected by a switch fabric 810 (e.g., a crossbar or shared memory switch fabric). The switch fabric 810 may, for example, conform to the Common Switch Interface (CSIX) or other fabric technologies such as HyperTransport, Infiniband, PCI-X, Packet-Over-SONET, RapidIO, and Utopia.

Individual line cards 800 may include one or more physical layer (PHY) devices 802 (e.g., optical, wired, and/or wireless) that handle communication over network connections. The physical layer devices 802 translate the physical signals carried by different network mediums into the bits (e.g., 1s and 0s) used by digital systems. The line cards 800 may also include framer devices 804 (e.g., Ethernet, Synchronous Optic Network (SONET), High-Level Data Link (HDLC) framers, and/or other layer 2 devices) that can perform operations on frames such as error detection and/or correction. The line cards 800 may also include one or more network processors 806 (such as network processor 100 shown in FIG. 1) to, e.g., perform packet processing operations on packets received via the physical layer devices 802. These packet processing operations can be performed by microengines programmed using the techniques described herein to enhance the efficiency of the network processors' operation.

While FIGS. 1 and 8 illustrate a network processor and a device incorporating one or more network processors, it will be appreciated that the systems and methods described herein can be implemented using other hardware, firmware, and/or software. In addition, the techniques described herein may be applied in a wide variety of network devices (e.g., routers, switches, bridges, hubs, traffic generators, and/or the like).

Thus, while several embodiments are described and illustrated herein, it will be appreciated that they are merely illustrative. Accordingly, other embodiments are within the scope of the following claims.

What is claimed is:

1. A method comprising:
generating code for execution by a plurality of virtual microengines; and
compiling and linking the code for execution on a physical microengine, including assigning physical microengine threads to a plurality of thread groups, the plurality of thread groups corresponding to the plurality of virtual microengines.

2. The method of claim 1, in which the number of threads assigned to each of the plurality of thread groups depends, at least in part, on the hardware characteristics of the physical microengine.

3. The method of claim 2, in which the number of threads assigned to each of the plurality of thread groups is automatically determined at link time.

4. The method of claim 1, further comprising:
configuring the physical microengine to support the plurality of thread groups; and
executing the threads.

5. The method of claim 4, in which configuring the physical microengine includes:
setting a program counter for each thread in each thread group to correspond to a location in instruction storage containing code for execution by each thread in the thread group.

6. The method of claim 4, in which each thread, when executed, is operable to process a packet of data received by the microengine.

7. A program embodied on a computer readable medium, the program having been generated, compiled, and linked according to the method of claim 1.

8. A set of instructions stored on a computer readable medium, the instructions, when executed by a processor, being operable to:
compile a program written for execution on a virtual microengine; and
link and load the program to enable it to be executed on a physical microengine;
wherein at least one of the compile, link, and load actions includes assigning a number of threads to a group of threads corresponding to the virtual microengine, the number of threads depending, at least in part, on the hardware characteristics of the physical microengine.

9. The set of instructions of claim 8, further including instructions that, when executed by a processor, are operable to:
allocate an intra-microengine next neighbor ring between two virtual microengines designed to run on the physical microengine.

10. The set of instructions of claim 8, further including instructions that, when executed by a processor, are operable to:
allocate microengine local memory to the group of threads.

11. The set of instructions of claim 8, further including instructions that, when executed by a processor, are operable to:
allocate a partition of a content addressable memory to the group of threads.

12. The set of instructions of claim 8, further including instructions that, when executed by a processor, are operable to:
set a program counter for each thread in the group of threads to a location in instruction storage containing a code image corresponding to the program.

13. A system comprising:
a microengine, the microengine configured to execute a plurality of threads, the threads corresponding to two or more virtual microengines;
a next neighbor ring operable to facilitate communication between two of the two or more virtual microengines.

14. The system of claim 13, in which the next neighbor ring comprises a partition of static random access memory on the microengine.

15. The system of claim 13, in which the next neighbor ring comprises at least a portion of an inter-microengine next neighbor ring corresponding to the microengine.

16. The system of claim 13, further comprising:
a control status register, the control status register including information regarding:
an assignment of threads to thread groups corresponding to the two or more virtual microengines;
an assignment of microengine local memory to the thread groups;
an assignment of partitions of a content addressable memory to the thread groups; and
an identification of an intra-microengine next neighbor ring corresponding to one or more of the thread groups.

17. A system comprising:
a switch fabric; and
one or more line cards comprising:
one or more physical layer components; and
one or more network processors, at least one of the network processors comprising:
a processing core; and
a plurality of microengines, at least one of the microengines being configured to execute a plurality of threads, the threads corresponding to two or more virtual microengines, and the at least one microengine having an intra-microengine next neighbor ring operable to facilitate communication between the two or more virtual microengines.

18. The system of claim 17, in which that at least one network processor further comprises:
a memory unit, the memory unit including code that, when executed by the 10 processing core, is operable to cause the network processor to perform actions comprising:
link and load programs written for execution on the two or more virtual microengines to enable the programs to be executed on the at least one microengine;
wherein at least one of the link and load actions includes assigning a number of threads to a group of threads corresponding to one of the two or more virtual microengines, the number of threads depending, at least in part, on the hardware characteristics of the at least one microengine.

19. The system of claim 18, in which the memory unit further includes code that, when executed by the processing core, is operable to:
allocate microengine local memory to the group of threads.

20. The system of claim 18, in which the memory unit further includes code that, when executed by the processing core, is operable to:
allocate a partition of a content addressable memory to the group of threads.
